(19) United States
(12) Patent Application Publication
(10) Pub. No.: US 2007/0136004 A1
(43) Pub. Date: Jun. 14, 2007

(54) Apparatus and method for searching for protein active site

(75) Inventors: Chan Yong Park, Daejeon-city (KR); Sung Hee Park, Daejeon-city (KR); Dae Hee Kim, Daejeon-city (KR); Seon Hee Park, Daejeon-city (KR)

Correspondence Address: MAYER, BROWN, ROWE & MAW LLP, 1909 K STREET, N.W., WASHINGTON, DC, 20006, US

(73) Assignee: ELECTRONICS AND TELECOMMUNICATIONS RESEARCH INSTITUTE

(21) Appl. No.: 11/637,812

(22) Filed: Dec. 13, 2006

(30) Foreign Application Priority Data
Dec. 12, 2005 (KR) 10-2005-0121984

(51) Int. Cl. G06F 19/00

(52) U.S. Cl. 702/19

(57) ABSTRACT

An apparatus and method for searching for a protein active site by using a bottom-hat transformation are provided. First, an image of protein surface is generated and then a volumetric image is generated by sampling the protein surface in units of a predetermined length. Thereafter a morphology process is performed on the volumetric image, thereby extracting the protein active site from the morphology-processed volumetric image. Accordingly, it is possible to rapidly search for a protein active site in a 3D structural space.

### CROSS-REFERENCE TO RELATED PATENT APPLICATION

This application claims the benefit of Korean Patent Application No. 10-2005-0121984, filed on Dec. 12, 2005, in the Korean Intellectual Property Office, the disclosure of which is incorporated herein in its entirety by reference.

### BACKGROUND OF THE INVENTION

1. Field of the Invention

The present invention relates to an apparatus and method for searching for a protein active site, and more particularly, to an apparatus and method for searching for a protein site which has a possibility of being a protein active site in a 3D structural space.

2. Description of the Related Art

In general, for protein structure comparison, a comparison method using distances between atoms of a protein is used. A protein structure comparison method known as DALI using distance matrices is disclosed in a paper titled “Protein Structure Comparison by Alignment of Distance Matrices”, (Journal of Molecular Biology, Vol. 203, 1993, pp. 23-138) by L. Holm and C. Sander. The protein structure comparison method represents distances between atoms of a protein with the distance matrices and detects similarities between the distance matrices.

In addition, a protein structure alignment algorithm known as LOCK is disclosed in a paper titled “Hierarchical Protein Structure Superposition Using Both Secondary Structure and Atomic Representations”, (Proc. Intelligent Proc. Intelligent Systems for Molecular Biology, 1997) by Amit P. Singh and Douglas L. Brutlag. This algorithm is based on alignment at both the secondary structure level and the atomic level of the protein, whereas past research is based on alignment at the atomic level of the protein.

However, due to characteristics of the 3D structural space, in that it is difficult to search for the protein active sites between two proteins in the 3D structural space. In addition, due to a large amount of calculations associated with the 3D structural space, it is difficult to rapidly perform calculations.

### SUMMARY OF THE INVENTION

The present invention provides an apparatus and method for rapidly searching for a protein active site in a 3D structural space.

According to an aspect of the present invention, there is provided an apparatus for searching for a protein active site, including: a surface generator generating an image of a protein surface; a data preprocessing unit generating a volumetric image by sampling the protein surface in units of a predetermined length; a data processing unit performing a morphology process on the volumetric image; and a postprocessing unit extracting an active site from the morphology-processed volumetric image.

According to another aspect of the present invention, there is provided a method of searching for a protein active site, including: generating an image of a protein surface; sampling the protein surface in units of a predetermined length and generating a volumetric image; performing a morphology process on the volumetric image; and extracting an active site from the morphology-processed volumetric image.

Accordingly, it is possible to rapidly search for a protein active site in a 3D structural space.

### BRIEF DESCRIPTION OF THE DRAWINGS

The above and other features and advantages of the present invention will become more apparent by describing in detail exemplary embodiments thereof with reference to the attached drawings in which:

FIG. 1 is a block diagram showing a structure of an apparatus for searching for a protein active site according to an embodiment of the present invention;

FIG. 2 is a view showing an example of a protein surface generated according to an embodiment of the present invention; and

FIG. 3 is a flowchart showing a method of searching for a protein active site according to an embodiment of the present invention.

### DETAILED DESCRIPTION OF THE INVENTION

The present invention will now be described more fully with reference to the accompanying drawings, in which exemplary embodiments of the invention are shown. The invention may, however, be embodied in many different forms and should not be construed as being limited to the embodiments set forth herein; rather, these embodiments are provided so that this disclosure will be thorough and complete, and will fully convey the concept of the invention to those skilled in the art. Like reference numerals in the drawings denote like elements.

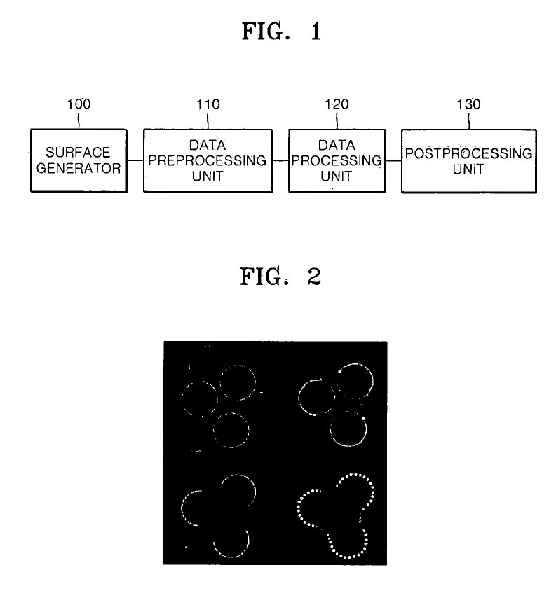

FIG. 1 is a block diagram of an apparatus for searching for a protein active site according to an embodiment of the present invention.

Referring to FIG. 1, the apparatus for searching for a protein active site includes a surface generator 100, a data preprocessing unit 110, a data processing unit 120, a postprocessing unit 130.

The surface generator 100 generates an image of a protein surface. More specifically, the surface generator 100 obtains Van der Waal's surfaces with respect to atoms constituting the protein. Thereafter, the surface generator 100 generates the image of the protein surface contacting a probe sphere by using the Van der Waal's surfaces. An example of the protein surface is shown in FIG. 2. The data preprocessing unit 110 performs sampling of the protein surface in units of 0.5 Å and generates a volumetric image. More specifically, the data preprocessing unit 110 generates an axis-aligned bounding box enclosing the protein and generates lattices for the axis-aligned bounding box in units of 0.5 Å. The data preprocessing unit 110 allocates 1 to lattice cells which are inside the protein surface and allocates 0 to lattice cells which are outside the protein surface. Also, the data preprocessing unit 110 allocates 1 to lattice cells when the protein occupies more than 50% of the volume of a lattice cell and allocates 0 to lattice cells when the protein occupies less than 50% of the volume of a lattice cell.

The data processing unit 120 performs a morphology process on the volumetric image generated by the data preprocessing unit 110. When X is defined as an n-dimensional binary image set and B is defined as a set of structuring elements b smaller than elements x of X, the morphology process may be a vector translation for motions of the structuring elements. When the morphology process is performed on all voxels, Equation 1 is obtained.
X±b={x±b|x∈X} [Equation 1]

Here, dilation is defined as Equation 2.

$$\begin{matrix}X ⊕ B = {⋃}_{b ∈ B} X + b \\ = \{ x + b \vert x ∈ X , b ∈ B \}\end{matrix} \qquad [ Equation 2 ]$$

Erosion is defined as Equation 3.

$$\begin{matrix}XΘB = {⋃}_{b ∈ B} X - b \\ = \{ z \vert ( B + z ) ⊆ X \}\end{matrix} \qquad [ Equation 3 ]$$

By using the dilation and erosion, opening operation and closing operation is defined as Equation 4.
Opening: X·B=(XΘB)⊕B
Closing: X·B=(X⊕B)ΘB [Equation 4]

Here, a bottom-hat transform is defined as Equation 5.
(X·B)−X [Equation 5]

Therefore, the data processing unit 120 can search for valley-shaped portions in 3D volumetric images by using the bottom-hat transformation.

The postprocessing unit 130 extracts the protein active site finally. More specifically, after the data processing unit 120 searches for the valley-shaped portions of the protein by using the bottom-hat transformation, the postprocessing unit 130 identifies atoms constituting the valley-shaped portions and determines the protein active site.

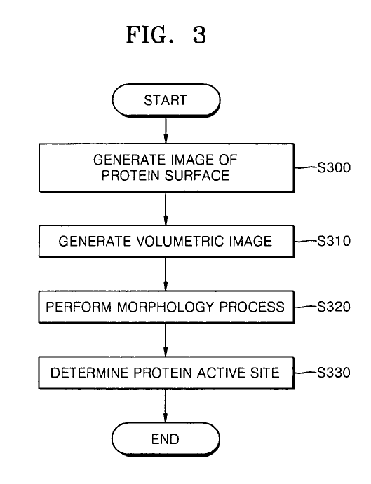

FIG. 3 is a flowchart showing a method of searching for a protein active site according to an embodiment of the present invention.

Referring to FIG. 3, Van der Waal's surfaces with respect to the atoms constituting the protein are obtained and an image of the protein surface contacting the probe sphere is generated by using the Van der Waal's surfaces (operation S 300). The axis-aligned bounding box enclosing the protein surface is generated, the lattices are generated for the axis-aligned bounding box in units of 0.5 Å, and the volumetric image is generated by allocating 1 to lattice cells which are inside the protein surface and allocating 0 to lattice cells which are outside the protein surface (operation S310).

Thereafter, the bottom-hat transformation, which is a morphology process, is performed on the volumetric image and the volumetric image is searched for valley-shaped portions using the bottom-hat transformation result (operation S320). Finally, the atoms constituting the valley-shaped portions are identified from the morphology-processed volumetric image and the protein active site is determined (operation S330).

Accordingly, the method of searching for a protein active site uses a mathematically proven algorithm such as the morphology process to search for a protein active site, and thereby searching for a geometric protein active site can be performed more rapidly.

The invention can also be embodied as computer readable codes on a computer readable recording medium. The computer readable recording medium is any data storage device that can store data which can be thereafter read by a computer system. Examples of the computer readable recording medium include read-only memory (ROM), random-access memory (RAM), CD-ROMs, magnetic tapes, floppy disks, optical data storage devices, and carrier waves (such as data transmission through the Internet). The computer readable recording medium can also be distributed over network coupled computer systems so that the computer readable code is stored and executed in a distributed fashion.

While the present invention has been particularly shown and described with reference to exemplary embodiments thereof, it will be understood by those skilled in the art that various changes in form and details may be made therein without departing from the spirit and scope of the invention as defined by the appended claims. The exemplary embodiments should be considered in descriptive sense only and not for purposes of limitation. Therefore, the scope of the invention is defined not by the detailed description of the invention but by the appended claims, and all differences within the scope will be construed as being included in the present invention.

What is claimed is:

1. An apparatus for searching for a protein active site, comprising:
a surface generator generating an image of a protein surface;
a data preprocessing unit generating a volumetric image by sampling the protein surface.
a data processing unit performing a morphology process on the volumetric image; and
a postprocessing unit extracting an active site from the morphology-processed volumetric image.

2. The apparatus of claim 1, wherein the surface generator generates the image of a protein surface contacting a probe sphere by using Van der Waals' surfaces with respect to atoms constituting the protein.

3. The apparatus of claim 1, wherein the data preprocessing unit generates an axis-aligned bounding box enclosing the protein surface, generates lattices in units of 0.5 Å for the axis-aligned bounding box, and generates the volumetric image by allocating 1 to lattice cells which are inside the protein surface and allocating 0 to lattice cells which are outside the protein surface.

4. The apparatus of claim 1, wherein the data processing unit performs a bottom-hat transformation which is one of the morphology processes on the volumetric image and searches for valley-shaped portions in the volumetric image.

5. The apparatus of claim 1, wherein the postprocessing unit identifies atoms constituting the valley-shaped portions of the volumetric image and determines the protein active site.

6. A method of searching for a protein active site, comprising:
generating an image of a protein surface;
sampling the protein surface and generating a volumetric image;
performing a morphology process on the volumetric image; and
extracting an active site from the morphology-processed volumetric image.

7. The method of claim 6, wherein the generating an image of a protein surface comprises:
obtaining Van der Waal's surfaces with respect to atoms constituting the protein; and
generating the image of the protein surface contacting a probe sphere by using the Van der Waal's surfaces.

8. The method of claim 6, wherein the sampling the protein surface in units of a predetermined length and generating a volumetric image comprises:
generating an axis-aligned bounding box enclosing the protein surface;
generating lattices in units of 0.5 Å for the axis-aligned bounding box; and
generating the volumetric image by allocating 1 to lattice cells which are inside the protein surface and allocating 0 to lattice cells which are outside the protein surface.

9. The method of claim 6, wherein the performing a morphology process on the volumetric image comprises:
performing a bottom-hat transformation on the volumetric image; and
searching the volumetric image for valley-shaped portions using the result of the bottom-hat transformation.

10. The method of claim 6, wherein the extracting an active site from the morphology-processed volumetric image comprises identifying atoms constituting the valley-shaped portions of the volumetric image and determining a protein active site.

11. A computer-readable medium having embodied thereon a computer program for executing the method of claim 6.
